(19) United States
(12) Patent Application Publication
(10) Pub. No.: US 2015/0286411 A1
(43) Pub. Date: Oct. 8, 2015

(54) MEMORY CONTROLLER, SEMICONDUCTOR MEMORY DEVICE, AND CONTROL METHOD OF MEMORY CONTROLLER

(71) Applicant: KABUSHIKI KAISHA TOSHIBA, Minato-ku (JP)

(72) Inventor: Jun ICHISHIMA, Kamakura-shi (JP)

(73) Assignee: KABUSHIKI KAISHA TOSHIBA, Minato-ku (JP)

(21) Appl. No.: 14/332,755

(22) Filed: Jul. 16, 2014

(30) Foreign Application Priority Data
Apr. 2, 2014 (JP) 2014-076344

(51) Int. Cl. G06F 3/06

(52) U.S. Cl. CPC G06F 3/0604; G06F 3/0653; G06F 3/0658; G06F 3/068; G06F 2003/0692

(57) ABSTRACT

According to one embodiment, a memory controller controls a semiconductor memory. The memory controller includes a first receiver, a transmitter, a second receiver, and a request transmitter.

### CROSS-REFERENCE TO RELATED APPLICATIONS

This application is based upon and claims the benefit of priority from Japanese Patent Application No. 2014-076344, filed Apr. 2, 2014, the entire contents of which are incorporated herein by reference.

### FIELD

Embodiments described herein relate generally to a memory controller, a semiconductor memory device, and a control method of a memory controller.

### BACKGROUND

As an example of a memory device, there is a hybrid-type memory device in which a plurality of kinds of memory media are combined. In the hybrid-type memory device, for example, a magnetic memory medium and a semiconductor memory are included.

There is a case in which a memory area of the semiconductor memory is divided into a plurality of memory banks (hereinafter referred to simply as “banks”). A memory controller of the semiconductor memory controls writing and reading of data to and from the plural banks, for example, based on an interleaving method.

### BRIEF DESCRIPTION OF THE DRAWINGS

FIG. 1 is a block diagram illustrating a configuration of a memory controller according to an embodiment;

FIG. 2 is a block diagram illustrating a storage device including the memory controller according to the embodiment;

FIG. 3 is a block diagram illustrating a configuration of an R/B controller according to the embodiment;

FIG. 4 is a flowchart illustrating a process of a bank controller according to the embodiment;

FIG. 5 is a flowchart illustrating a process of a request arbiter and the R/B controller according to the embodiment;

FIG. 6 is a timing chart illustrating a request issuance control based on an R/B signal of a comparative example;

FIG. 7 is a timing chart illustrating a first example of a request issuance control based on the embodiment; and

FIG. 8 is a timing chart illustrating a second example of a request issuance control based on the embodiment.

### DETAILED DESCRIPTION

In general, according to one embodiment, a memory controller controls a semiconductor memory. The memory controller includes a first receiver, a transmitter, a second receiver, and a request transmitter. The first receiver is configured to receive a ready/busy signal which is indicative of busy when at least one of a plurality of banks of the semiconductor memory is in a busy state, and is indicative of ready when at least two of the plurality of banks are in a ready state. The transmitter is configured to send, when the ready/busy signal is indicative of the busy, a status read request inquiring of a bank included in the plurality of banks as to whether the bank is in the ready state or in the busy state. The second receiver is configured to receive a status signal as a response to the status read request. The request transmitter is configured to send a request to a ready-state bank included in the plurality of banks, based on the status signal and the ready/busy signal.

Embodiments will be described hereinafter with reference to the accompanying drawings. In the description below, almost or substantially the same functions and structural elements are denoted by like reference numerals, and a description thereof is given where necessary.

### Embodiment

In the present embodiment, a description is given of a memory controller which generates bank ready/busy information (hereinafter referred to as “bank R/B information”) which is indicative of whether a specific bank included in a plurality of banks is busy (Busy state) or ready (Ready state), a semiconductor memory device, and a control method of the memory controller.

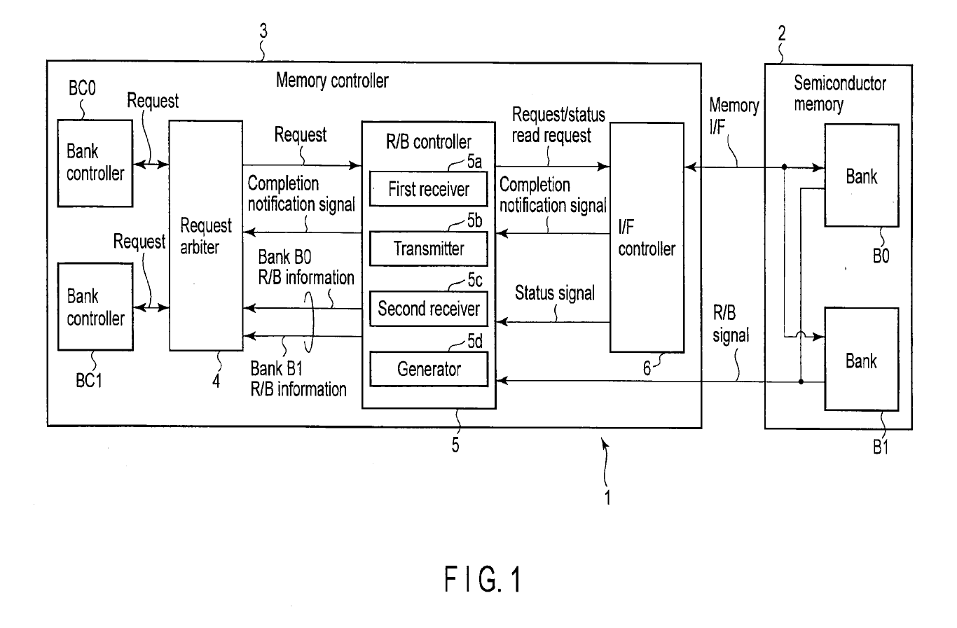

FIG. 1 is a block diagram illustrating a configuration of the memory controller according to an embodiment.

A semiconductor memory device 1 includes a semiconductor memory 2 and a memory controller 3.

The semiconductor memory 2 may be a volatile semiconductor memory, or a nonvolatile semiconductor memory. In the embodiment, the semiconductor memory 2 is a nonvolatile semiconductor memory, for instance, a NAND-type flash memory, but the semiconductor memory 2 may be a memory such as a NOR-type flash memory, an MRAM (Magnetoresistive Random access memory), a PRAM (Phase change Random access memory), an ReRAM (Resistive Random access memory)) or an FeRAM (Ferroelectric Random Access Memory).

A memory area of the semiconductor memory 2 is divided into a plurality of banks B0, B1. In the present embodiment, in order to make the description simple, the case in which the number of banks is two is described by way of example, but the number of banks may be three or more.

In the semiconductor memory 2, one ready/busy signal (hereinafter referred to as “R/B signal”) is shared between two banks B0, B1. In other words, the R/B signal is indicative of “busy”, when at least one of banks B0, B1 is in a busy state. The R/B signal is indicative of “ready”, when both of the banks B0, B1 are in a ready state.

Although a memory interface (hereinafter referred to as “memory I/F”) between the semiconductor memory 2 and memory controller 3 is assumed to be one channel, the same control is applicable to two or more channels.

The memory controller 3 is electrically connected to the semiconductor memory 2, and controls the semiconductor memory 2. The memory controller 3 executes automatic issuance of a status read request. To be more specific, the memory controller 3 receives an R/B signal from the semiconductor memory 2, automatically issues a status read request in accordance with the R/B signal, and generates bank R/B information which indicates whether each of the banks B0, B1 is in a busy state or in a ready state.

The memory controller 3 includes bank controllers BC0, BC1, a request arbiter 4, a ready/busy controller (hereinafter referred to as “R/B controller”) 5, and an interface controller (hereinafter referred to as “I/F controller”) 6.

The bank controller BC0 executes queueing of requests to the bank B0. The bank controller BC0 sends to the request arbiter 4 the requests to the bank B0.

The bank controller BC1 executes queueing of requests to the bank B1. The bank controller BC1 sends to the request arbiter 4 the requests to the bank B1.

The request is, for instance, an access request for data read or write.

The request, which is sent from the bank controller BC0, BC1 to the request arbiter 4, includes flag information which indicates whether the request may be issued even if the bank B0, B1 is in the busy state.

The request arbiter 4 includes an arbitration function of receiving requests from the bank controllers BC0, BC1, and executing arbitration as to which of the requests is to be given priority.

For example, the request arbiter 4 selects a request which can be issued to the bank B0, B1, based on the bank R/B information of each bank B0, B1, which has been received from the R/B controller 5, and the flag information included in the request received from the bank controller BC0, BC1. For example, the request arbiter 4 preferentially selects a request to a ready-state bank or a request to which a flag indicating that the request can be issued even in the busy state is added. When a plurality of requests can be issued, the request arbiter 4 selects a request, for example, by using round-robin or LRU (Least Recently Used) control.

Then, the request arbiter 4 sends the selected request to the R/B controller 5. In addition, the request arbiter 4 sends to the R/B controller 5 a request presence/absence signal which indicates whether a request from the bank controller BC0, BC1 is present or not.

The R/B controller 5 includes a first receiver 5a, a transmitter 5b, a second receiver 5c and a generator 5d.

The first receiver 5a receives a request from the request arbiter 4. In addition, the first receiver 5a receives an R/B signal from the semiconductor memory 2.

The transmitter 5b sends a status read request, which inquires of either the bank B0 or B1 as to whether the bank is in the ready state or busy state, to the bank B0, B1 via the I/F controller 6, when the R/B signal is indicative of “busy”.

The second receiver 5c receives a status signal as a response to the status read request.

The generator 5d generates, based on the received status signal, bank R/B information which indicates whether a specific bank is in the busy state or ready state.

In other words, the R/B controller 5 receives a request from the request arbiter 4, and selects whether to issue this request or to issue a status read request, and sends the selected request or status read request to the I/F controller 6.

When the R/B controller 5 has sent the status read request to the I/F controller 6, the R/B controller 5 internally generates or updates the bank R/B information of each bank B0, B1, based on the status signal received via the I/F controller 6 as a response to the status read request, or the R/B signal received from the semiconductor memory 2.

The bank R/B information of the bank B0 indicates whether the bank B0 is in the ready state or in the busy state.

The bank R/B information of the bank B1 indicates whether the bank B1 is in the ready state or in the busy state.

The R/B controller 5 sends the bank R/B information of each bank B0, B1 to the request arbiter 4.

The I/F controller 6 controls a memory I/F. Upon receiving a request, which is to be executed, from the R/B controller 5, the I/F controller 6 sends the request to the semiconductor memory 2 according to the memory I/F. When the request is an access request, the I/F controller 6 executes access to the semiconductor memory 2. The I/F controller 6 sends a completion notification signal for the request to various controllers such as the request arbiter 4 and R/B controller 5. When the request is a read request, the I/F controller 6 sends an access result, such as data read out from the semiconductor memory 2, to various controllers. The I/F controller 6 may send the completion notification signal and access request to the request arbiter 4 via the R/B controller 5, or to the bank controller BC0, BC1 via the request arbiter 4.

Further, upon receiving a status read request from the R/B controller 5, the I/F controller 6 sends the status read request to the semiconductor memory 2 according to the memory I/F. The I/F controller 6 sends a status signal to the R/B controller 5 as a response to the status read request.

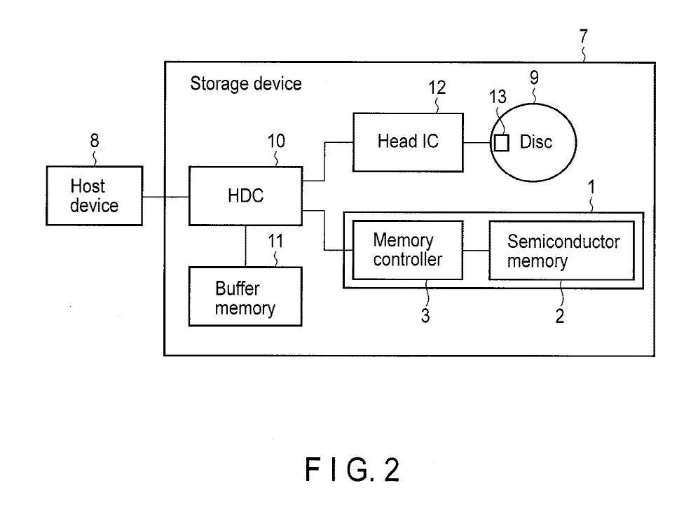

FIG. 2 is a block diagram illustrating a storage device including the memory controller 3 according to the embodiment.

A storage device 7 is a hybrid-type hard disk drive (HDD). However, the storage device 7 may be, for instance, an SSD (Solid State Drive).

The storage device 7 stores a large volume of data in the semiconductor memory 2 and a disk 9 which is a magnetic memory medium, according to the control of a host device 8.

The storage device 7 includes a hard disk controller (HDC) 10, a buffer memory 11, a head IC (Integrated Circuit) 12, the disk 9, and a head 13.

The HDC 10 controls an interface between the storage device 7 and the host device 8, and controls data write and data read in and from the semiconductor memory 2 and the disk 9.

The buffer memory 11 temporarily stores, according to the control of the HDC 10, write data or read data for data transfer between the storage device 7 and the host device 8. As the buffer memory 11, for example, a DRAM (Dynamic Random Access Memory) is used.

The head IC 12 is a head amplifier integrated circuit which controls the head 13 according to the HDC 10.

The head 13 moves on the disk 9 according to the control of the head IC 12, reads data stored in the disk 9, and write data in the disk 9.

The memory controller 3 controls the semiconductor memory 2 according to the HDC 10. The bank controller BC0, BC1 included in the memory controller 3 executes queueing of transfer requests which are transferred from the HDC 10.

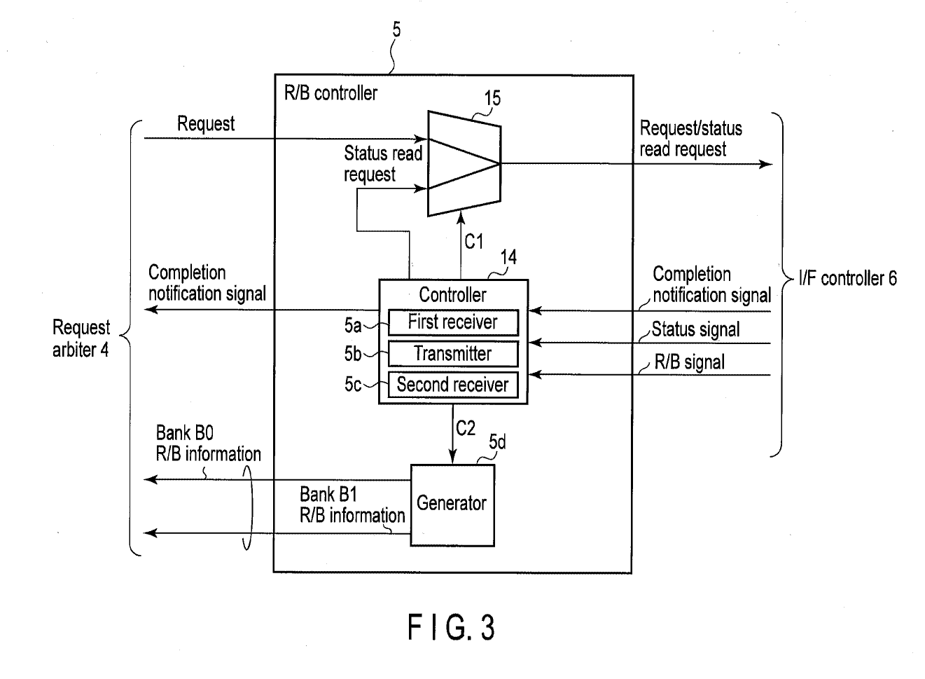

FIG. 3 is a block diagram illustrating a configuration of the R/B controller 5 according to the embodiment.

The R/B controller 5 includes a controller 14, a selector 15, and the generator 5d.

The controller 14 includes the above-described first receiver 5a, transmitter 5b and second receiver 5c.

The selector 15 receives a request from the request arbiter 4 and a status read request that is issued by the controller 14, selects either the request or the status read request in accordance with a control signal C1 from the controller 14, and sends the selected request or status read request to the I/F controller 6.

The controller 14 receives a completion notification signal and a status signal from the I/F controller 6, and an R/B signal from the semiconductor memory 2.

The generator 5d generates or updates bank R/B information of each bank B0, B1, in accordance with a control signal C2 from the controller 14, and sends the R/B information to the request arbiter 4.

A description will now be given of the generation of the bank R/B information of the bank B0 in the R/B controller 5, and the selection of the request or the status read request to the bank B0. Incidentally, the same process as in the case of the bank B0 to be described below is executed for the bank B1.

When the R/B signal is indicative of “ready”, the generator 5d sets both the bank R/B information of the bank B0 and the bank R/B information of the bank B1 to be “ready”.

The transmitter 5b receives a signal indicating whether a request to the bank B0 is present or not from the request arbiter 4, and when the bank R/B information of the bank B0 is indicative of “busy” despite the presence of the request being detected, the transmitter 5b selects, by the selector 15, not the request but the status read request, and sends the status read request.

The second receiver 5c receives the status signal for the bank B0.

The generator 5d updates the bank R/B information for the bank B0 to “ready” when the status signal for the bank B0 is indicative of “ready”, and asserts an update flag which indicates that the bank R/B information for the bank B0 has been updated.

When the update flag for the bank B0 is asserted, the transmitter 5b sends to the I/F controller 6 the request to the bank B0 which has been received from the request arbiter 4, and the generator 5d de-asserts the update flag for the bank B0.

When the R/B signal has changed from “ready” to “busy” as the result of sending to the I/F controller 6 the request for the bank B0 which was received from the request arbiter 4, the generator 5d sets the bank R/B information for the bank B0 to be “busy”.

Even when the R/B signal is indicative of “busy”, the transmitter 5b sends the status read request to the I/F controller 6.

After the transmitter 5b transmitted the status read request to the I/F controller 6, if the bank R/B information of the bank B0 is not indicative of “ready”, the transmitter 5b sends, after the passing of a predetermined time, the status read request once again to the I/F controller 6.

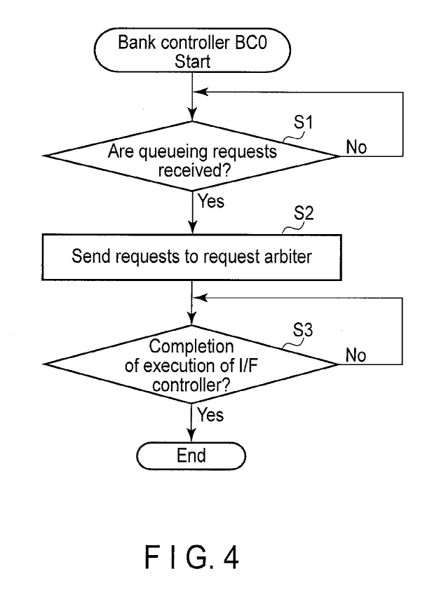

FIG. 4 is a flowchart illustrating a process of the bank controller BC0 according to the embodiment. Incidentally, the process of the bank controller BC1 is the same as illustrated in FIG. 4.

In step S1, the bank controller BC0 determines whether there are queueing requests which have been transferred from the HDC 10. If there is no queueing request, the bank controller BC0 repeats step S1.

If there are queueing requests, the bank controller BC0, in step S2, sends the requests to the request arbiter 4.

In step S3, the bank controller BC0 repeats step S3 until receiving an execution completion notification from the I/F controller 6 via the request arbiter 4.

When the execution of the request has been completed, the bank controller BC0 terminates the process.

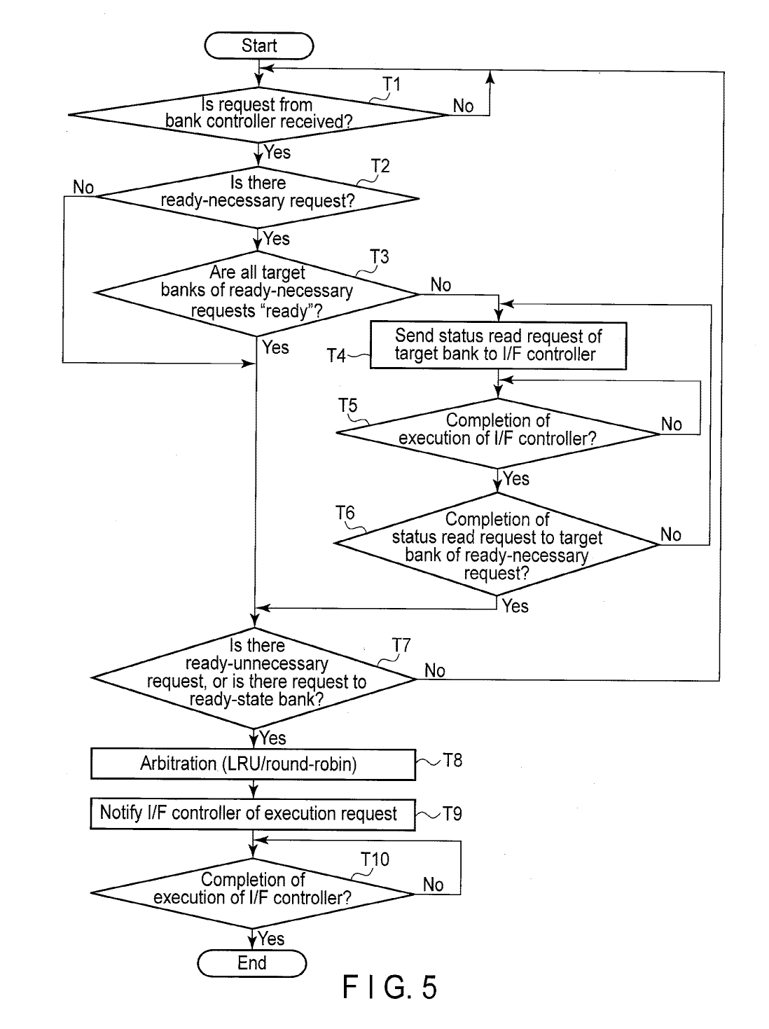

FIG. 5 is a flowchart illustrating a process of the request arbiter 4 and R/B controller 5 according to the embodiment.

In step T1, the request arbiter 4 determines whether a request has been received from the bank controller BC0, BC1.

When no request has been received, the request arbiter 4 repeats step T1.

When a request has been received, the request arbiter 4, in step T2, determines, based on the flag information of the request, whether there is a ready-necessary request which requires that a target bank be in the ready state.

When there is no ready-necessary request, the process goes to step T7.

When there is a ready-necessary request, the process advances to step T3.

In step T3, the request arbiter 4 determines whether all target banks of the ready-necessary requests are in the ready state, based on the flag information and the bank R/B information.

When all target banks of the ready-necessary requests are not in the ready state, the process goes to step T4.

When all target banks of the ready-necessary requests are in the ready state, the process advances to step T7.

In step T4, the R/B controller 5 sends a status read request for the target bank to the I/F controller 6.

In step T5, the R/B controller 5 stands by for the execution of the status read request in the I/F controller 6.

In step T6, the R/B controller 5 determines whether a completion notification signal of the status read request for the target bank of the ready-necessary request has been received or not.

When the completion notification signal of the status read request has not been received, the process goes to step T4.

When the completion notification signal of the status read request has been received, the process goes to step T7.

In step T7, based on the flag information and bank R/B information, the request arbiter 4 determines whether there is a read-unnecessary request which does not require that the target bank be in the ready state, or whether there is a request to a bank that is in the ready state.

When there is neither a ready-unnecessary request nor a request to the bank that is in the ready state, the process goes to step T1.

When there is a ready-unnecessary request or a request to the bank that is in the ready state, the request arbiter 4 executes arbitration in step T8, and sends the request to the I/F controller 6 via the R/B controller 5 in step T9.

In step T10, the request arbiter 4 stands by for the execution of the request in the I/F controller 6. Upon receiving a completion notification signal of the request, the request arbiter 4 terminates the process.

In the meantime, in FIG. 5, the method of issuing the status read request can be properly changed. For example, the issuance of the status read request may be stopped at a time point when the ready state of a preferential one of the banks B0 and B1 has been recognized. For example, even when there is no request, if the memory I/F is usable, the status read request may be issued. The status read request may be issued at set intervals.

In the above-described embodiment, the bank R/B information of each bank B0, B1 can be generated or updated at a proper timing, and an interleave access to the semiconductor memory 2 can be made efficient.

In the present embodiment, a status read request is issued independently from a queued request, and the bank R/B information of each bank B0, B1 can automatically generated or updated.

In the present embodiment, whether the bank B0, B1 is in the ready state or in the busy state is monitored without depending on the R/B signal alone. Instead, by generating and monitoring the bank R/B information of each bank B0, B1, the sending of the request to the ready-state bank is facilitated, and the issuance of the request to the bank B0, B1 can efficiently be executed.

In this embodiment, the issuance of the request can be made efficient by the modification of only the memory controller 3. For example, since there is no need to modify the firmware, etc. included in the storage device 7, the application of the embodiment is easy.

Next, the effectiveness of the embodiment will be described by comparing the control based on an R/B signal in a comparative example, and the control relating to the present embodiment. Although the case of controlling the issuance of requests to the banks B0, B1 is described by way of example, the same applies to the case of controlling the execution of program commands.

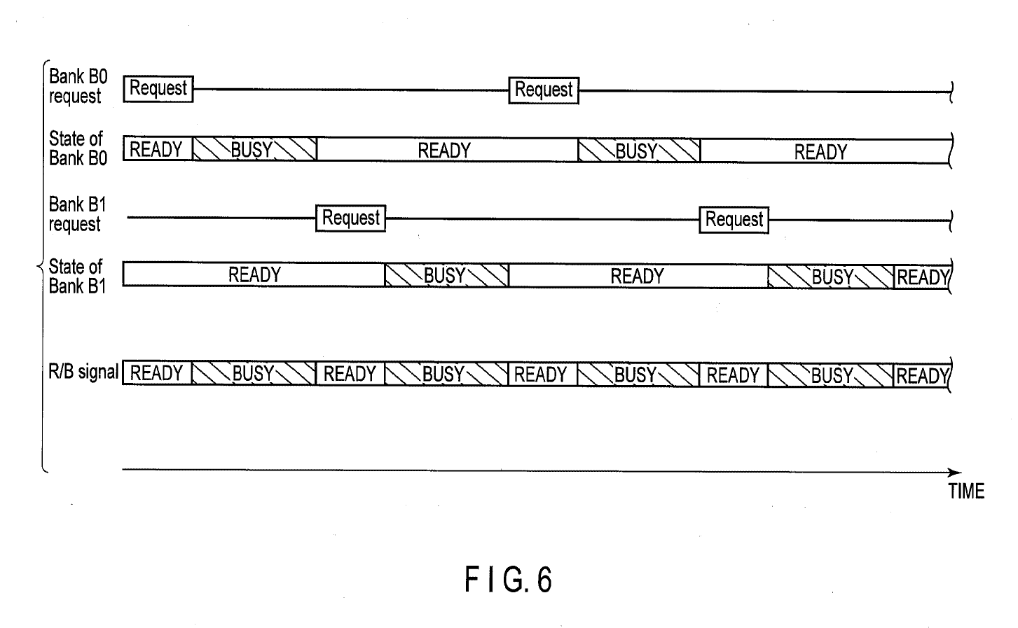

FIG. 6 is a timing chart illustrating request issuance control based on an R/B signal of a comparative example.

FIG. 6 illustrates, from above to below, the state of issuance of a request which is issued to the bank B0, the state of the bank B0, the state of issuance of a request which is issued to the bank B1, the state of the bank B1, and the state of an R/B signal. In this case, the R/B signal, as described above, is shared by the banks B0 and B1. The R/B signal is indicative of “ready” when both of the banks B0 and B1 are in the ready state, and the R/B signal is indicative of “busy” when at least one of the banks B0, B1 is in the busy state.

In the comparative example, the issuance of the request is controlled by using only the R/B signal of the memory I/F. For example, when the bank B0 is in the ready state and the bank B1 is in the busy state, the R/B signal is indicative of “busy”. Thus, the issuance of the request to the ready-state bank B0 is hindered. It is possible to check whether each bank B0, B1 is in the ready state or in the busy state, by queueing status read requests in each bank controller BC0, BC1, and issuing the status read requests from the bank controller BC0, BC1. However, the timing at which the status read request becomes necessary varies depending on the characteristics of the semiconductor memory 2 and the request execution state. It is thus difficult to estimate in advance the timing of issuing the status read request from the bank controller BC0, BC1. Hence, when the bank B0, B1 is to be accessed efficiently, it is not possible to queue a plurality of requests in advance in each bank controller BC0, BC1.

In the above-described timing chart of the comparative example of FIG. 6, if the request has been issued to the bank B0, the bank B0 enters the busy state, and thus the R/B signal is indicative of “busy”. Thus, the issuance of the request to the ready-state bank B1 cannot be executed. In the control of the comparative example, each time the R/B signal indicates “ready”, the requests are alternately issued to the banks B0 and B1, and the banks B0 and B1 are accessed.

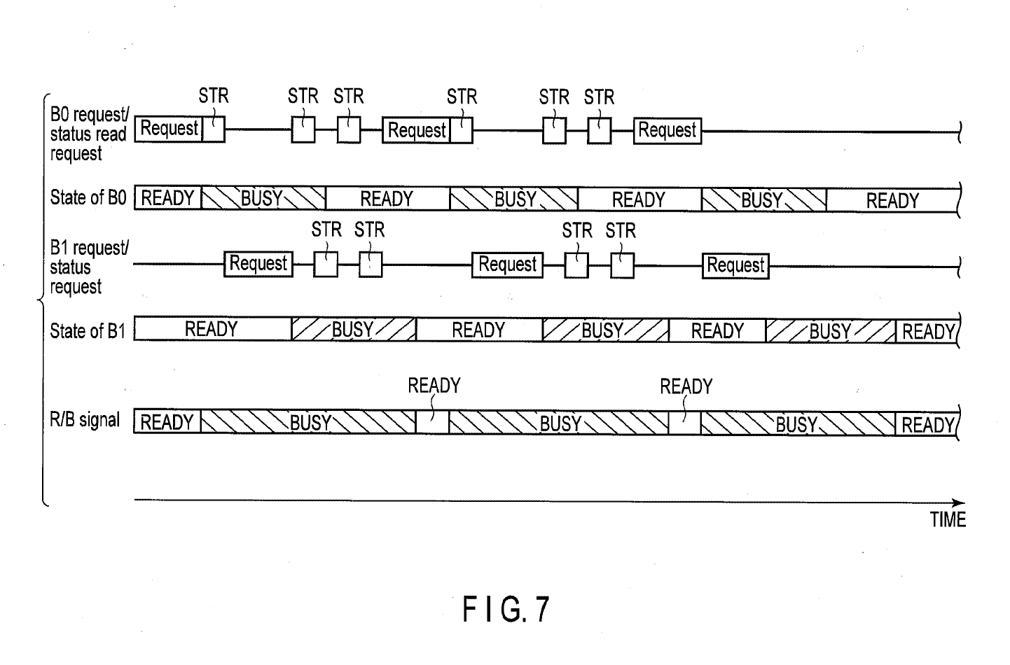

FIG. 7 is a timing chart illustrating a first example of the request issuance control based on the embodiment.

FIG. 7 illustrates, from above to below, the state of issuance of a request and a status read request (STR) which are issued to the bank B0, the state of the bank B0, the state of issuance of a request and a status read request which are issued to the bank B1, the state of the bank B1, and the state of an R/B signal.

Each of the bank controller B0 and bank controller B1 queues three requests (program commands).

In the initial state, since both of the banks B0 and B1 are in the ready state, a first request is first issued to the bank B0.

If the first request has been issued, the R/B signal indicates “busy”, but a second request is present in the bank B0. Thus, a status read request is issued to the bank B0, the state of the bank B0 is checked, and bank R/B information for the bank B0 is generated.

After the bank R/B information for the bank B0 has been generated, the bank B0 is in the busy state, but the bank B1 remains in the ready state.

Thus, a first request of the bank B1 is issued.

Thereafter, status read requests are issued to the bank B0 and bank B1, respectively, and bank R/B information for the bank. B0, B1 is generated.

At a timing when the bank R/B information for the bank B0 has become “ready”, the R/B information for the bank B1 is “busy”, and the request to the bank B1 is present. Thus, after the status read request is issued to the bank B1, a second request of the bank B0 is executed.

While the second request to the bank B0 is being issued, the R/B signal becomes “ready”. Thus, the bank R/B information for the bank B1 is updated to “ready”.

If the second request has been issued to the bank B0, the R/B signal indicates “busy”, but there is a third request for the bank B0. Thus, a status read request is issued to the bank B0, the state of the bank B0 is checked, and bank R/B information for the bank B0 is generated.

After the bank R/B information for the bank B0 has been generated, the bank B0 is in the busy state, but the bank B1 is in the ready state.

Thus, a second request of the bank B1 is issued.

The above control is repeated, and when a request to a bank that is in the busy state is present, a status read request is polled for the bank that is in the busy state, and a request is issued to a bank that is in the ready state.

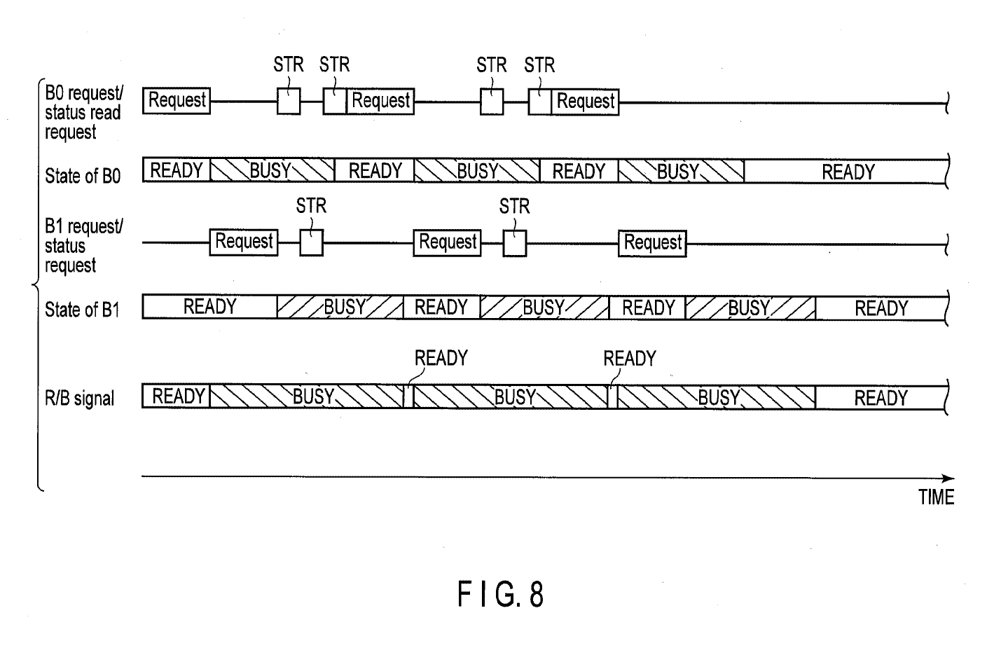

FIG. 8 is a timing chart illustrating a second example of the request issuance control based on the embodiment. In the second example of FIG. 7, like the above-described first example of FIG. 7, FIG. 8 illustrates, from above to below, the state of issuance of a request and a status read request which are issued to the bank B0, the state of the bank B0, the state of issuance of a request and a status read request which are issued to the bank B1, the state of the bank B1, and the state of an R/B signal.

Each of the bank controller B0 and bank controller B1 queues three requests, and the priority order is LRU control (top priority is given to a bank that is not executed recently).

After a first request is issued to the bank B0, the bank B1 is given top priority, and the bank R/B signal for the bank B1 remains indicative of “ready” state. Thus, no status read request is issued, and a firs request is issued to the bank B1.

After the first request of the bank B1 is issued, the bank B0 is given top priority, and polling of a status read request is started from the top-priority bank B0. At a time point when the ready state of the top-priority bank B0 has been detected, the polling of the status read request is ended, and a second request of the bank B0 is issued.

In the case where the second request of the bank B0 has been issued and the bank B1 is given top priority but the state of the bank B0 is yet to change from the ready state to the busy state and the state of the bank B0 remains indicative of “ready” state, if the bank B1 changes from the busy state to the ready state, both the banks B0 and B1 enter the ready state and the R/B signal indicates “ready” state. Then, the ready state of the top-priority bank B1 is detected, and a second request of the top-priority bank B1 is issued.

Thereafter, the above control is repeated.

In the second example, since the status read requests are issued in the order from the top-priority bank, the memory I/F can be used more efficiently than in the first example.

As compared in FIG. 6 to FIG. 8, the request issuance can be made efficient by the memory controller 3 according to the present embodiment.

In this embodiment, the functions of the respective controllers can be freely combined or separated. For example, the request arbiter 4 and the R/B controller 5 may be combined.

In the present embodiment, for example, the status read command may be issued precedently, without depending on the presence/absence of requests.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller configured to control a semiconductor memory, comprising:
a first receiver configured to receive a ready/busy signal which is indicative of busy when at least one of a plurality of banks of the semiconductor memory is in a busy state, and is indicative of ready when at least two of the plurality of banks are in a ready state;
a transmitter configured to send, when the ready/busy signal is indicative of the busy, a status read request inquiring of a bank included in the plurality of banks as to whether the bank is in the ready state or in the busy state;
a second receiver configured to receive a status signal as a response to the status read request; and
a request transmitter configured to send a request to a ready-state bank included in the plurality of banks, based on the status signal and the ready/busy signal.

2. The memory controller of claim 1, further comprising a generator configured to generate a bank ready/busy signal indicating whether the bank is in the busy state or in the ready state, based on the status signal and the ready/busy signal,
wherein the request transmitter is configured to send the request to the ready-state bank, based on the bank ready/busy signal.

3. The memory controller of claim 2, wherein the plurality of banks include a first bank and a second bank,
the transmitter is configured to send the status read request to both the first bank and the second bank in case where the ready/busy signal is indicative of the busy,
the second receiver is configured to receive, as a response to the status read request, a first status signal from the first bank and a second status signal from the second bank, and
the generator is configured to generate, based on the first status signal, a first bank ready/busy signal indicating whether the first bank is in the busy state or in the ready state, and to generate, based on the second status signal, a second bank ready/busy signal indicating whether the second bank is in the busy state or in the ready state.

4. The memory controller of claim 2, wherein the plurality of banks include a first bank which is preferentially used and a second bank,
the transmitter is configured to send the status read request to the first bank when the ready/busy signal is indicative of the busy,
the second receiver is configured to receive the status signal as a response to the status read request from the first bank, and
the generator is configured to generate, based on the ready/busy signal and the status signal, a first bank ready/busy signal indicating whether the first bank is in the busy state or in the ready state.

5. The memory controller of claim 2, wherein the plurality of banks include a first bank and a second bank,
the bank ready/busy signal includes a first bank ready/busy signal indicating whether the first bank is in the busy state or in the ready state, and a second bank ready/busy signal indicating whether the second bank is in the busy state or in the ready state, and
the transmitter is configured to send the status read request to the first bank when a first request to the first bank occurs and the first bank ready/busy signal is indicative of the busy, and to send the status read request to the second bank when a second request to the second bank occurs and the second bank ready/busy signal is indicative of the busy.

6. The memory controller of claim 5, wherein the generator is configured to update the first bank ready/busy signal, based on the status signal received from the first bank,
to update the second bank ready/busy signal, based on the status signal received from the second bank,
to set the first bank ready/busy signal and the second bank ready/busy signal to be the ready, when the ready/busy signal is indicative of the ready,
to set the first bank ready/busy signal to be the busy, when the first request has been sent to the first bank and the ready/busy signal has changed from the ready to the busy, and
to set the second bank ready/busy signal to be the busy, when the second request has been sent to the second bank and the ready/busy signal has changed from the ready to the busy.

7. A semiconductor memory device comprising:
the memory controller of claim 1; and
the semiconductor memory which is controlled by the memory controller.

8. The device of claim 7, wherein the memory controller further comprising a generator configured to generate a bank ready/busy signal indicating whether the bank is in the busy state or in the ready state, based on the status signal and the ready/busy signal,
wherein the request transmitter is configured to send the request to the ready-state bank, based on the bank ready/busy signal.

9. The device of claim 8, wherein the plurality of banks include a first bank and a second bank,
the transmitter is configured to send the status read request to both the first bank and the second bank in case where the ready/busy signal is indicative of the busy,
the second receiver is configured to receive, as a response to the status read request, a first status signal from the first bank and a second status signal from the second bank, and
the generator is configured to generate, based on the first status signal, a first bank ready/busy signal indicating whether the first bank is in the busy state or in the ready state, and to generate, based on the second status signal, a second bank ready/busy signal indicating whether the second bank is in the busy state or in the ready state.

10. The device of claim 8, wherein the plurality of banks include a first bank which is preferentially used and a second bank,
the transmitter is configured to send the status read request to the first bank when the ready/busy signal is indicative of the busy,
the second receiver is configured to receive the status signal as a response to the status read request from the first bank, and
the generator is configured to generate, based on the ready/busy signal and the status signal, a first bank ready/busy signal indicating whether the first bank is in the busy state or in the ready state.

11. The device of claim 8, wherein the plurality of banks include a first bank and a second bank,
the bank ready/busy signal includes a first bank ready/busy signal indicating whether the first bank is in the busy state or in the ready state, and a second bank ready/busy signal indicating whether the second bank is in the busy state or in the ready state, and
the transmitter is configured to send the status read request to the first bank when a first request to the first bank occurs and the first bank ready/busy signal is indicative of the busy, and to send the status read request to the second bank when a second request to the second bank occurs and the second bank ready/busy signal is indicative of the busy.

12. The device of claim 11, wherein the generator is configured to update the first bank ready/busy signal, based on the status signal received from the first bank,
to update the second bank ready/busy signal, based on the status signal received from the second bank,
to set the first bank ready/busy signal and the second bank ready/busy signal to be the ready, when the ready/busy signal is indicative of the ready,
to set the first bank ready/busy signal to be the busy, when the first request has been sent to the first bank and the ready/busy signal has changed from the ready to the busy, and
to set the second bank ready/busy signal to be the busy, when the second request has been sent to the second bank and the ready/busy signal has changed from the ready to the busy.

13. A control method of a memory controller configured to control a semiconductor memory, comprising:
receiving a ready/busy signal which is indicative of busy when at least one of a plurality of banks of the semiconductor memory is in a busy state, and is indicative of ready when at least two of the plurality of banks are in a ready state;
sending, when the ready/busy signal is indicative of the busy, a status read request inquiring of a bank included in the plurality of banks as to whether the bank is in the ready state or in the busy state;
receiving a status signal as a response to the status read request; and
sending a request to a ready-state bank included in the plurality of banks, based on the status signal and the ready/busy signal.

14. The control method of claim 13, further comprising generating a bank ready/busy signal indicating whether the bank is in the busy state or in the ready state, based on the status signal and the ready/busy signal,
wherein the sending the request includes sending the request to the ready-state bank, based on the bank ready/busy signal.

15. The control method of claim 14, wherein the plurality of banks include a first bank and a second bank,
the sending the status read request includes sending the status read request to both the first bank and the second bank in case where the ready/busy signal is indicative of the busy,
the receiving the status signal includes receiving, as a response to the status read request, a first status signal from the first bank and a second status signal from the second bank, and
the generating the bank ready/busy signal includes generating, based on the first status signal, a first bank ready/busy signal indicating whether the first bank is in the busy state or in the ready state, and generating, based on the second status signal, a second bank ready/busy signal indicating whether the second bank is in the busy state or in the ready state.

16. The control method of claim 14, wherein the plurality of banks include a first bank which is preferentially used and a second bank,
the sending the status read request includes sending the status read request to the first bank when the ready/busy signal is indicative of the busy,
the receiving the status signal includes receiving the status signal as a response to the status read request from the first bank, and
the generating the bank ready/busy signal includes generating, based on the ready/busy signal and the status signal, a first bank ready/busy signal indicating whether the first bank is in the busy state or in the ready state.

17. The control method of claim 14, wherein the plurality of banks include a first bank and a second bank,
the bank ready/busy signal includes a first bank ready/busy signal indicating whether the first bank is in the busy state or in the ready state, and a second bank ready/busy signal indicating whether the second bank is in the busy state or in the ready state, and
the sending the status read request includes sending the status read request to the first bank when a first request to the first bank occurs and the first bank ready/busy signal is indicative of the busy, and sending the status read request to the second bank when a second request to the second bank occurs and the second bank ready/busy signal is indicative of the busy.

18. The control method of claim 17, wherein the generating the bank ready/busy signal includes:
updating the first bank ready/busy signal, based on the status signal received from the first bank,
updating the second bank ready/busy signal, based on the status signal received from the second bank,
setting the first bank ready/busy signal and the second bank ready/busy signal to be the ready, when the ready/busy signal is indicative of the ready,
setting the first bank ready/busy signal to be the busy, when the first request has been sent to the first bank and the ready/busy signal has changed from the ready to the busy, and
setting the second bank ready/busy signal to be the busy, when the second request has been sent to the second bank and the ready/busy signal has changed from the ready to the busy.
